(19) United States
(12) Patent Application Publication
(10) Pub. No.: US 2019/0107385 A1
(43) Pub. Date: Apr. 11, 2019

(54) BEAD MEASUREMENT SYSTEM WITH A MOVABLE CAMERA

(71) Applicant: Bartell Machinery Systems, L.L.C., Rome, NY (US)

(72) Inventor: Kevin Richard Razy, Lee Center, NY (US)

(73) Assignee: Bartell Machinery Systems, L.L.C., Rome, NY (US)

(21) Appl. No.: 16/106,859

(22) Filed: Aug. 21, 2018

Related U.S. Application Data
(60) Provisional application No. 62/548,186, filed on Aug. 21, 2017.

(51) Int. Cl. G01B 11/12; G01B 11/16

(52) U.S. Cl. CPC G01B 11/12; G01B 11/16

(57) ABSTRACT

A measurement system for measuring at least one parameter of a tire component may include a background surface, a circular visual indicator located on the background surface, a support arm that is rotatable about an axis, and a camera secured to the support arm. When the support arm rotates about the axis, the camera may follow a circular path along the background surface.

### RELATED APPLICATIONS

This application claims the benefit of U.S. provisional application Ser. No. 62/548,186, filed Aug. 21, 2017, which is herein incorporated by reference in its entirety.

### BACKGROUND

A vehicle tire generally has two annular bead rings at the innermost diameter, which provide the tire with hoop strength and structural integrity. The beads also provide stiffness at the point where the tire mounts to a rim. Beads are generally manufactured by winding metal wire in a groove on the outer periphery of a chuck or drum, often called a former. A bead may also be formed from a single wire or multiple wires joined together.

Often, a single manufacturing facility may produce several types of beads with varying sizes and shapes. Several parameters of the beads are generally measured after the manufacturing process for purposes of quality control to ensure a high-quality final product. For example, certain parameters of the beads often must fall within a tolerance of 0.005 inches to meet the established quality standards. Parameters that are typically measured may include the inner diameter, height, width, and weight of the tire bead. Some existing measurement devices contact the tire bead when taking a measurement, thereby potentially distorting the tire bead during the measurement and potentially hiding defects.

It is therefore desired to provide an accurate and precise measurement system that can measure a variety of types and sizes of tire beads without undue contact to the tire bead during the measurement process.

### BRIEF SUMMARY

One general aspect of the present disclosure includes a measurement system for measuring at least one parameter of a tire component. The measurement system may include a background surface, a circular visual indicator located on the background surface, a support arm that is rotatable about an axis, and a camera secured to the support arm. When the support arm rotates about the axis, the camera may follow a circular path along the background surface.

Another general aspect includes a measurement system for measuring at least one parameter of a tire component having a background surface, a support arm that is rotatable about an axis (the axis being substantially perpendicular to the background surface), and a first measurement device secured to the support arm. The first measurement device may be movable along the support arm from a first position to a second position.

Another general aspect includes a method including placing a tire component on a support surface in a manner such that the tire component is at least approximately concentric with a circular visual indicator located on a background surface, determining a measured distance with a camera (where the measured distance is a distance between the tire component and the circular visual indicator), and determining a parameter of the tire component based on the measured distance.

### BRIEF DESCRIPTION OF THE DRAWINGS

FIG. 1 is an illustration showing a perspective view of an embodiment of a system for determining at least one parameter of a tire component in accordance with certain embodiments of the present disclosure.

FIG. 2 is an illustration showing a view from the perspective of a camera with an entocentric lens when viewing a tire component located on a support surface of the embodiment of the system of FIG. 1.

FIG. 3 is an illustration showing a perspective view of a portion of a system for determining a parameter of a tire component, where the system comprises an extension with a second background surface in accordance with certain embodiments of the present disclosure.

FIG. 4 is an illustration showing a perspective view of a system for determining a parameter of a tire component with a body having a cavity.

FIG. 5 is an illustration showing a measurement system having a movable camera in accordance with certain embodiments of the present disclosure.

FIG. 6 is an illustration showing a top view of a portion of the measurement system depicted in FIG. 5.

### DETAILED DESCRIPTION

The invention is described with reference to the drawings in which like elements are referred to by like numerals. The relationship and functioning of the various elements of this invention are better understood by the following detailed description. However, the embodiments of this invention are not limited to the embodiments illustrated in the drawings. It should be understood that the drawings are not to scale, and in certain instances details have been omitted which are not necessary for an understanding of the present invention, such as conventional fabrication and assembly.

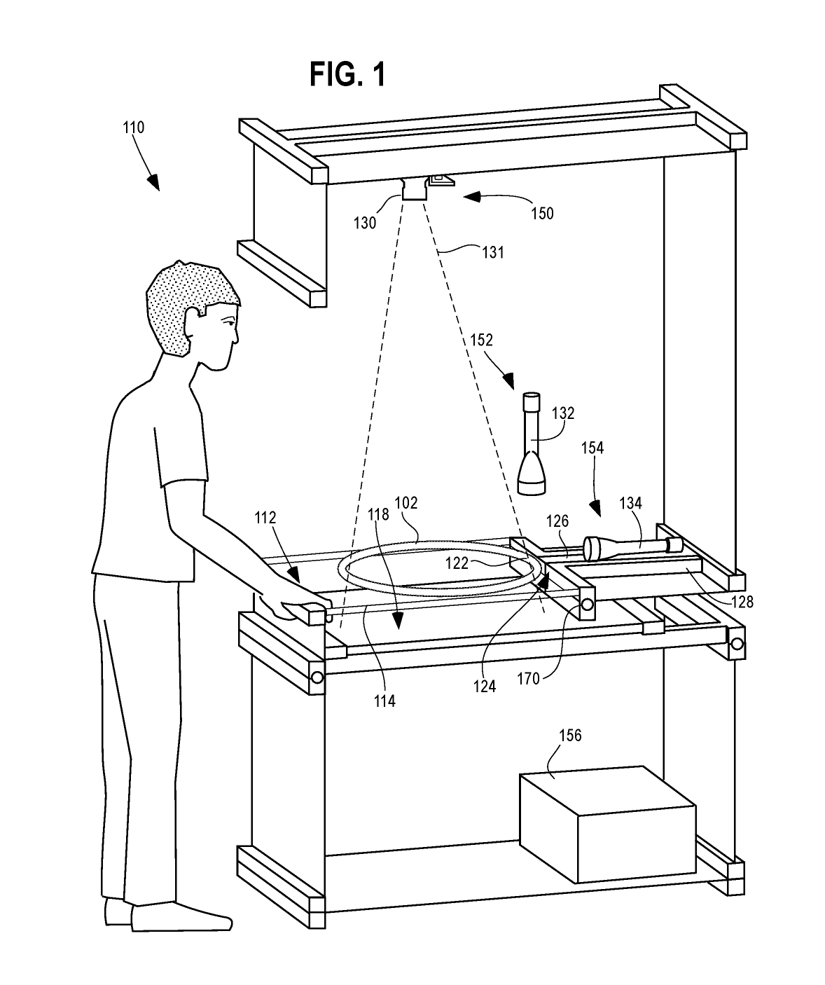

FIG. 1 shows a system 110, which may be configured to determine one or more parameters of a tire component. The tire component may be, for example, an annular body, such as a tire bead 102. The system 110 may alternatively or additionally be configured to determine parameters of other circular or annular bodies (or bodies of another shape).

The system 110 may include a support surface 112 configured to support the tire bead 102 (or another component). The support surface 112 may be defined by a transparent body 114, such as a sheet of glass, a sheet of transparent plastic, etc. In exemplary embodiments, the transparent body 114 is a sheet of low impurity glass (for example, an ultra-clear soda-lime float glass manufactured by Starphire). In some embodiments, the support surface 112 may include markings or other visual indicators that indicate the proper placement of the tire bead 102 during the process of determining a parameter. The transparent body 114 may be held by a frame 120.

A background surface 118 may be included below the support surface 112. In one non-limiting example, the background surface 118 may be substantially parallel to the support surface 112 and may be spaced approximately 4 inches from the support surface 112 (though any other suitable spacing may be used). The background surface 118 is preferably viewable from the perspective of a first measurement device 150, which may include a first camera 130. In addition to, or in the alternative to, the first camera 130, the first measurement device 150 may include any other non-contact detection or measurement device (e.g., an optical sensor or the like). A backlight may be included to illuminate the background surface. In some embodiments, the background surface 118 is defined by a backlight. The background surface 118 may be configured for optimal compatibility with the first camera 130. For example, the background surface 118 may be uniformly polished, may include a particular color, or may include other visual or other indicia that the first camera is particularly sensitive to.

The first camera 130 may be a high-resolution camera, such as a 29 megapixel Allied Vision Technologies high resolution camera with an entocentric lens such as an Edmund Optics 35 mm F-Mount lens. The first camera 130 may have any other suitable type of lens (e.g., a telecentric lens). The first measurement device 150 may additionally include image recognition and processing software, and/or may be electrically connected to a computer 156 configured to recognize and process image data provided by the first camera 130, to obtain a measurement. For example, the first camera 130 and the associated image recognition and processing software of the first measurement device 150 and/or the computer 156 may be configured to recognize and measure any breaks or discontinuities in the view of the background surface 118 from the perspective of the lens of the first measurement device 150 may be calibrated with respect to the support surface 112. For example, each pixel of an image provided by the first camera 130 may be associated with a particular distance that is determined and/or set during calibration.

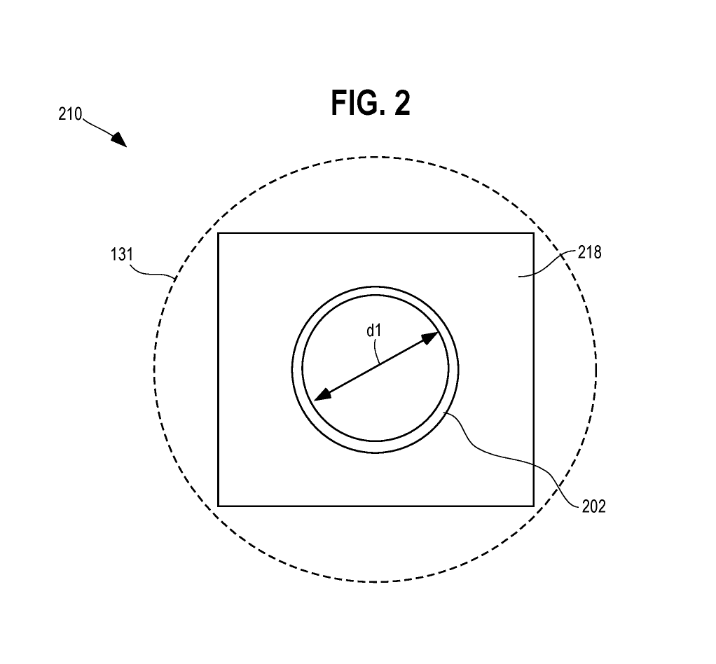

To illustrate, the first camera 130 may face the support surface 112 and the background surface 118 such that at least a portion of the support surface 112 and at least a portion of the background surface 118 are within the field of view of the first camera 130. When a tire bead 102 or other component is placed on the support surface 112, at least a portion of the background surface 118 (which, as described above, may be backlit) may be blocked from view by the first camera 130. The image viewed by the first camera is illustrated by image 210 with a field of view 131 of FIG. 2. It is noted that the image 210 may only exist in the form of data (for example inside the measurement device 150 or the computer 156).

The first measurement device 150 may be configured to utilize software to measure a dimension d1, which corresponds to the inner diameter parameter of the tire bead 102. With reference to FIG. 2, the first portion 218 of the image 210 corresponds to the unblocked portion of the background surface 118 from the perspective of the first camera 130, and the second portion 202 corresponds to the portion of the background surface 118 blocked from view by the tire bead 102. The measurement device 150 and/or the computer 156 may, for example, recognize the dimension depicted as the dimension d1 and determine its length. The first camera 130 and/or the computer 156 may additionally or alternatively be configured to recognize and measure any other dimension.

In some embodiments, the first camera 130 may have an entocentric lens providing a conical field of view (shown as the field of view 131). Advantageously, an entocentric lens typically has a large maximum working distance (i.e., the maximum distance from the lens of the first camera 130 to the component being measured). Further, the entocentric lens may be capable of viewing a large area (particularly when placed at a relatively large distance from the support surface 112, as the viewing area will increase with distance), thereby providing the ability for the system 110 to view and measure many different types and sizes of tire beads 102. In one non-limiting embodiment (for illustrative purposes only), the entocentric lens of the first camera 130 may be placed approximately 36 inches from the support surface 112, and the system 110 may be capable of measuring beads having an inner diameter ranging from approximately 12 inches to approximately 25 inches. Advantageously, many different types and sizes of beads may be measured using the first camera 130 without significant repositioning or replacement of the components of the system 110.

The magnification effects (e.g., the reduced apparent size with increased distance) of an entocentric lens may require a measurement correction when the dimension d1 (of FIG. 2) is measured to determine the inner diameter parameter of the tire bead 102, for example when the minimum inner diameter of the tire bead 102 is not directly adjacent to the support surface 112 (e.g., when the tire bead 102 has a circular cross-section such that the minimum inner diameter is a certain height above the support surface 112). When certain variables are known (e.g., the distance from the camera lens to the support surface 112 and height of the measured dimension above the support surface 112), the measured dimension can be converted to determine the parameter by using principles of trigonometry. In one example, the dimension d1 of FIG. 2 corresponding to the inner diameter of the tire bead 102 can be measured by the first measurement device 150, as described above. The dimension d1 can then be incorporated into a mathematical sequence to determine the true size of the inner diameter parameter of the tire bead 102. For example, when the perceived radius of the dimension d1, the distance of the tire bead 102 to the first camera 130, and the height of the minimum inner diameter above the support surface 112 are known, trigonometry may be used to determine the actual inner diameter parameter of the tire bead 102.

Referring back to FIG. 1, the system 110 may additionally include a second measurement device 152 with a second camera 132 and/or a third measurement device 154 with a third camera 134. As depicted in FIG. 1, the second camera 132 of the second measurement device 154 is oriented such that its field of view is substantially parallel to the field of view 131 of first camera 130, though this is not necessarily required in all embodiments. Like the first camera 130, the second camera 132 may utilize the background surface 118. The measurement device 152 may be configured to determine a second parameter of the tire bead 102, such as the height of the tire bead 102 as shown.

The second camera 132 may be a camera with a telecentric lens for directly measuring the second parameter (e.g., the height) of the tire bead 102. A telecentric lens is capable of producing an orthographic view of its subject without magnification, and therefore the image magnification may be independent of the distance or position of the subject. One example of a telecentric lens that may be used is a TCCR23056 lens manufactured by Opto Engineering. The telecentric lens of the second camera 132 may be positioned above the support surface 112 such that the tire bead 102 will fall within the working range (which, for example, may be from about 1.5 inches to about 4.5 inches) of the telecentric lens when placed on the support surface 112. Accordingly, the telecentric lens of the second camera 132 may directly measure the second parameter (e.g., height) of the tire bead 102. Herein, the phrase “directly measure” means that a measurement may be accomplished without correcting for magnification due to distance from a lens. This direct measurement may also be independent from the position of the tire bead 102 with respect to the field of view of the second camera 132. Advantageously, using a second camera 132 with a telecentric lens may minimize the necessity for precise placement of the tire bead 102 prior to the measurement of the second parameter, and may allow the system 110 to operate to determine the second parameter of multiple sizes and variations of the tire bead 102. Measurement devices utilizing telecentric lenses are also typically capable of achieving highly-accurate measurements.

A third camera 134 of a third measurement device 154, shown in FIG. 1, may be oriented such that its field of view is substantially perpendicular to the field of view of the second camera 132 and the first camera 130. The third measurement device 154 may be configured to determine a third parameter of the tire bead 102 (e.g., a width of the tire bead 102). Like the second camera 132, the third camera 134 may have a telecentric lens such that the third measurement device 154 is capable of directly measuring the third parameter. Advantageously, providing a third camera 134 with a telecentric lens may allow for the direct determination of the third parameter of the multiple sizes and variations of the tire bead 102 and without the precise positioning of the tire bead 102 on the support surface 112. In some embodiments, an extension 136 with a second background surface 138 may be provided. The second background surface 138 may be located generally in the field of view of the third camera 134 and may be configured for optimal compatibility with the third camera 134 and to provide contrast with respect to the tire bead 102. Like the first background surface 118, the second background surface 138 may be backlit and/or may be defined by a backlight.

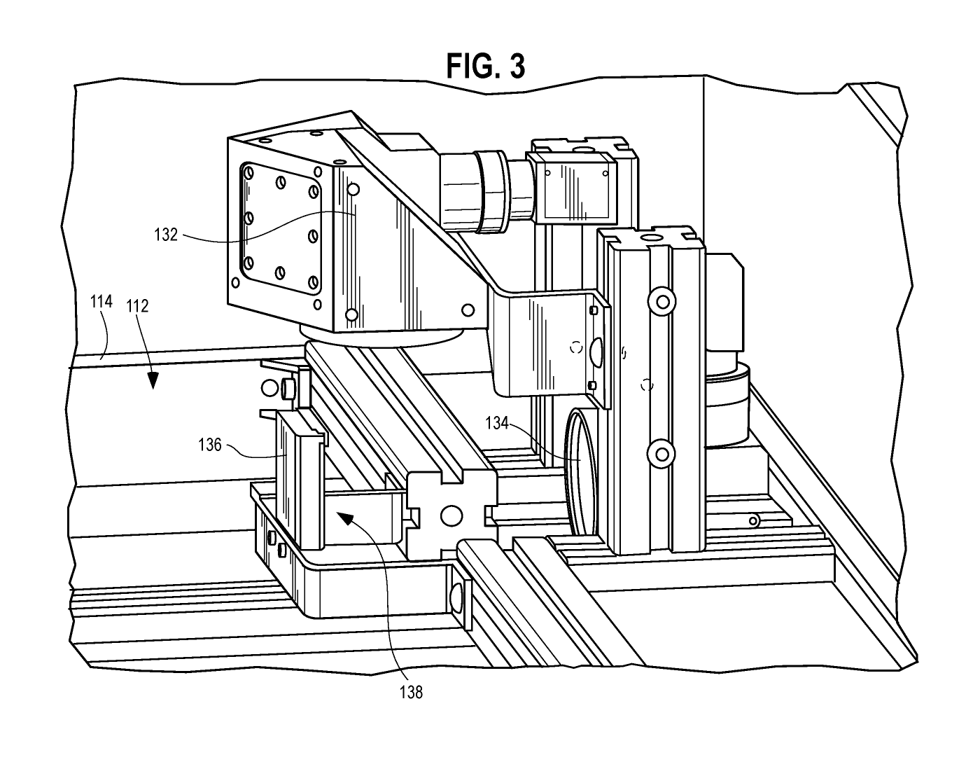

In some embodiments, still referring to FIG. 1, the system 110 may include one or more positioning devices, such one or more abutment surfaces 122 and 124. The abutment surfaces 122 and 124 may be included on the frame 120 which at least partially supports the transparent body 114. In addition, or alternatively, an extension may be provided from the support surface 112 (such as extension 136 shown in FIG. 3), which may include at least one abutment surface for properly positioning the tire bead 102. The second camera 132 may be located with respect to the abutment surfaces 122 and 124 such that, when the tire bead 102 is positioned into contact with the abutment surfaces 122 and 124, the tire bead 102 is substantially aligned with the field of view of the second camera 132 such that the second camera 132 can measure the second parameter (e.g., the height) of the tire bead 102. Advantageously, the abutment surfaces 122 and 124 may provide simplicity in suitable positioning of the tire bead 102 on the support surface 112 in a measurement system such that the system 110 can obtain measurements, thereby providing increased manufacturing efficiency and increased accuracy of the measurement results. Further, the third camera 134 may be positioned such that the tire bead 102 is at a distance within the working range of the lens of the third camera 134 when in contact with the abutment surfaces 122 and 124. For example, this may be accomplished when the third camera 134 is positioned at least partially between two frame members 126 and 128 having the respective abutment surfaces 122 and 124, as shown.

It is contemplated that the position of the third camera 134 may be vertically adjustable (manually or automatically) to correspond with the width of the tire bead 102 (e.g., when a tire bead 102 with a relatively large width is measured, the third camera 134 may be adjusted upward to ensure the entirety of the width of the tire bead 102 is within view of the telecentric lens of the third camera 134). Alternatively, the position of the support surface 112 may be adjustable. In some embodiments, the size of the field of view of the third camera 134 may be sufficient such that this vertical adjustment is unnecessary.

The system 110 may have a measurement device configured to measure the mass or weight of a component placed on the support surface 112 (e.g., the tire bead 102). For example, as shown in FIG. 1, at least one load cell 170 may be operably connected to the support surface 112. The load cell 170 may be placed underneath the frame 120, which supports the transparent body 114. In exemplary embodiments, one load cell may be placed under the frame 120 supporting the transparent body 114 at positions corresponding to each of the four corners of the transparent body 114. When multiple load cells are used, the sum of the forces on the calibrated load cells (i.e., the total force minus the weight force provided on the load cells when no component is placed on the support surface 112) will correspond to the weight of the tire bead 102 (and/or another component) placed on the support surface 112. The load cells may provide the measured weight to the computer 156.

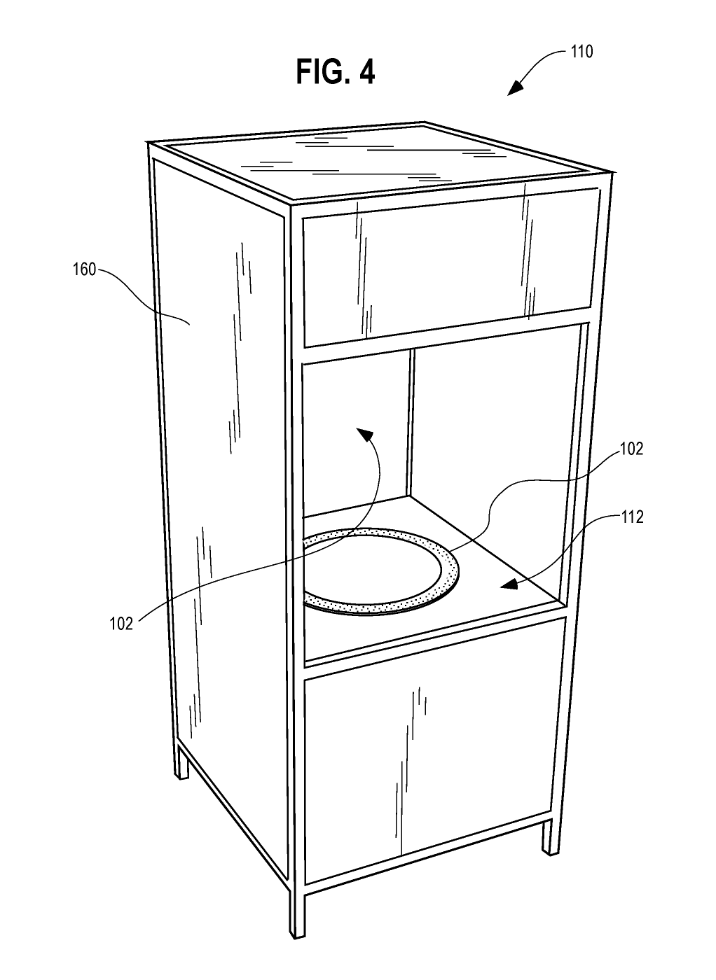

In some embodiments, and as depicted by FIG. 4, the system 110 may include a body 160 with a cavity 162. As shown, the support surface 112 may define at least a portion of the bottom of the cavity 162. The first camera 130 (described above with reference to FIG. 1) may be located adjacent to the top of the cavity 162. The second and third cameras 132 and 134 (described above with reference to FIG. 1) may be located within the cavity 162 or may be located out of the cavity 162 but face towards the cavity 162 to view a component on the support surface 112. The cavity 162 may include a door (not shown) that may close during the measurement of the tire bead 102 or other component. Advantageously, enclosing the cavity 162 during the measurement of at least one parameter may substantially keep ambient light from the cavity 162. The backlights described above may therefore be substantially the only source providing light within the cavity 162. This may decrease interruption by ambient light and increase the accuracy and precision of the above-described measurement devices. It is contemplated that the walls and other surfaces within the cavity 162 may be optimized such that reflections of the light provided by the backlights are substantially eliminated or otherwise do not interfere with the operation of the cameras.

It is contemplated that, in some embodiments, the system 110 described above may be a part of a larger assembly line where tire beads are placed on the support surface 112 (of FIG. 1) automatically, for example through the use of a conveyor system. Further, in some embodiments, the body 160 of the system 110 (shown in FIG. 4) may have castors and therefore may be movable, which may be advantageous for storage and portability in a manufacturing environment.

The current embodiments are advantageous, as they may provide the measurement of physical parameters of a tire component (such as the inner diameter, height, width, and weight of a tire bead) without distorting its form during the measurement process. This results in a highly accurate and precise measurement. Further, a single system can be utilized to measure the parameters of a variety of different sized components. Further, the tire component may be easily and quickly placed into the system and removed.

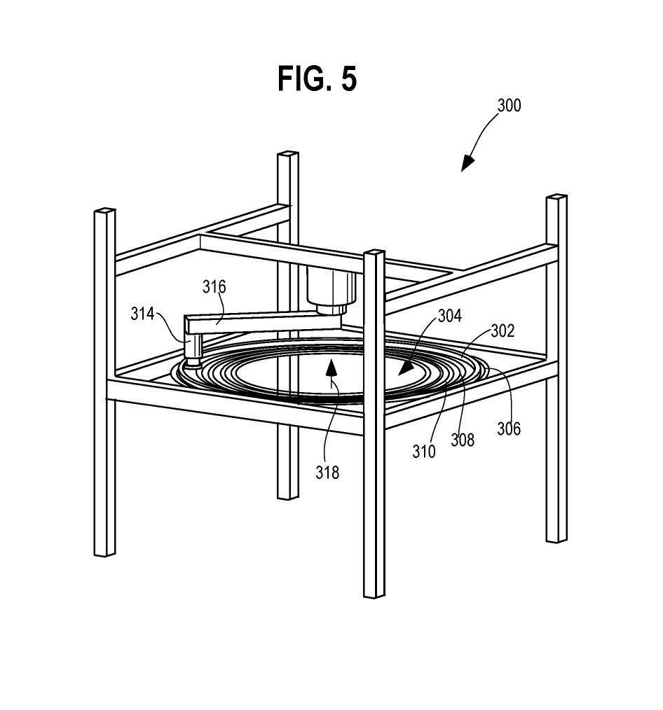

FIG. 5 is an illustration showing another embodiment of a measurement system 300 which may be used for measuring at least one parameter of a tire component (which in this case is the depicted bead 302, but other tire components or other circular objects are also contemplated). Any of the features described with respect to the measurement system 300 may be included with the embodiments described above, and vice versa. As described in more detail below, the measurement system 300 may include a movable measurement device, which in FIG. 5 is depicted as a camera 314. The camera 314 may be movable by way of a support arm 316 that is rotatable about an axis 318.

Referring to FIG. 5, the measurement system 300 may include a background surface 304 (depicted as transparent, which is optional). The background surface 304 may double as a support surface that directly contacts and supports the tire bead 302. In other embodiments, a separate translucent or substantially transparent support surface may be placed on top of the background surface 304 (or may be spaced from the background surface 304, as described above). The background surface may include at least one circular visual indicator 306, and in some embodiments, more than one circular visual indicator may be included (e.g., a second circular visual indicator 308, a third circular visual indicator 310, and so forth). The visual indicators 306, 308, 310 may alternatively be shaped as something other than a circle, but the circular shape may be advantageous when measuring circular dimensions of tire components.

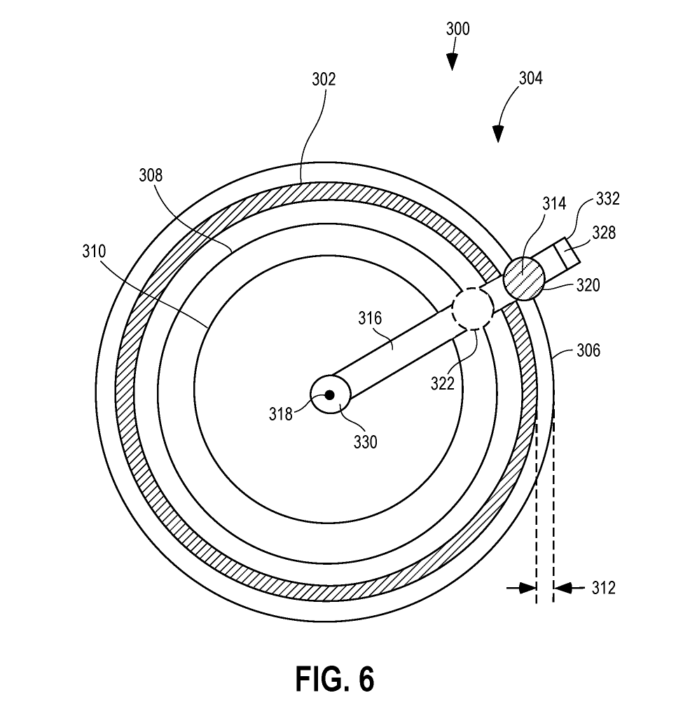

FIG. 6 is an illustration showing a top view of a portion of the system 300 depicted in FIG. 5. Referring to FIG. 6, when the tire bead 302 is placed on the background surface 304, the tire bead 302 may be positioned such that it is at least approximately concentric with the visual indicator 306. While not shown, positioning devices may be included to assist in concentric positioning (e.g., upward-extending protrusions with abutment surfaces). The visual indicator 306 may have one or more known dimensions, such as a known diameter. Thus, a parameter of the tire bead 302 (e.g., a bead diameter) may be determined by first measuring a distance 312 between the tire bead 302 and the visual indicator 306, and then calculating the parameter of the tire bead based on this measured distance 312. The distance 312 may be determined through use of any suitable measurement device, such as the camera 314. The camera 314 may be any suitable type of camera with any suitable lens type, and it may have any of the features described with respect to other cameras discussed above.

As shown, the camera 314 may be attached to the support arm 316, and the support arm 316 may be rotatable about the axis 318. The axis 318 may be substantially perpendicular to the background surface 304 and may be substantially concentric with the visual indicator 306 such that, when the support arm 316 rotates, the camera 314 rotates along a circular path that is also substantially concentric with the visual indicator 306. Therefore, as the support arm 316 rotates, the camera 314 may move along the circular visual indicator 306 while collecting/recording a series of measurements of the distance 312 between the tire bead 302 and the visual indicator 306. The series of measurements may then be averaged or otherwise manipulated to determine, with high accuracy, the parameter (e.g., diameter or other dimension) of the tire bead 302. For example, the camera may take 5, 10, 20, 50, 100, 1,000, 10,000, or even more individual measurements of the distance 312 when traveling around the device's circumference to determine the parameter of the tire bead 302 with very high accuracy.

In some embodiments, the camera 314 may be linearly movable with respect to the support arm 316. That is, the camera 314 may be movable along the support arm 316 from a first position 320 to a second position 322, and more than two positions are contemplated. In the first position 320, the circular path of the camera's motion may have a first diameter. In the second position 322, the circular path of the camera 314 may have a second diameter that is smaller than the first diameter. Advantageously, when a different size tire bead 302 is loaded into the measurement system 300, and/or when a different parameter is going to be measured, the camera 314 can move from the first position 320 to the second position 322. The measurement system 300 may therefore be capable of measuring many types/sizes of tire beads or other components along with many different parameters (e.g., an outer diameter vs. an inner diameter). Further, as described in more detail below, the size of the bead or other component measured is not limited by the field of view of the camera 314. Thus, beads or other components can be measured with high accuracy even when their size extends beyond the camera's field of view.

When the camera is located in the first position 320, the diameter of the circular path of motion of the camera 314 may be substantially equal to the diameter of the circular visual indicator 306. Further, the camera's path may be substantially concentric with the circular visual indicator 306. This location and orientation may ensure that the camera 314 will accurately and precisely follow the circular visual indicator throughout its rotation, which enhances the accuracy of its measurements with respect to other orientations. Similarly, in the second position 322, the camera 314 may be substantially concentric with the second visual indicator 308 and the diameter of its circular path of motion may be substantially equal to the diameter of the second visual indicator 308. Any suitable number of positions of the camera 314 may be possible for communication with any number of visual indicators. It is also contemplated that the camera 314 may be movable to one or more positions that do not directly correspond with any particular visual indicator, and the camera 314 may rely only on where the circular component is located in its field of view (e.g., versus an expected position) to measure certain parameters.

In some embodiments, the camera 314 may be movable along the support arm 316 manually. That is, the camera 314 may be slidably connected to the support arm 316 and may be moved by a user from one location to another and then optionally locked in place. However, in non-limiting exemplary embodiments, a linear actuation device 328 may be mechanically coupled to the camera 314. Actuation of the linear actuation device 328 may move the camera 314 closer to, or further from, the end 332 of the support arm 316. The linear actuation device 328 may be a servo motor that is electrically connected to a control device providing control over its actuation (e.g., such as the computer 156 of FIG. 1), but any other suitable device may be used. The linear actuation device 328 may be substantially fixed with respect to the support arm 316, but it is also contemplated that it may be fixed with respect to the camera 314 such that it moves with the camera 314 along the support arm 316. Using an automatic linear actuation device 328 may be advantageous for precision in camera positioning, for high speed, and for the ability to automate certain measurements.

Additionally or alternatively, a rotation actuation device 330 may be mechanically coupled to the support arm 316 and configured to rotation the support arm 316 with respect to the background surface 304. The position of the rotation actuation device 330 may be fixed with respect to the background surface 304. Further, the rotation actuation device 330 may be positioned with respect to the background surface 304 such that the axis 318 extends through the center of the circular visual indicator 306. Like the linear actuation device 328 described above, the rotation actuation device 330 may be electrically connected to a controller (e.g., a computer) for automatic operation. In some embodiments, the total rotation of the rotation actuation device 330 may be limited to 360 degrees or less to avoid the necessity for electronic slip plates or other components providing communication with the linear actuation device 328, but in other embodiments, more than 360 degrees of rotation may be allowed.

Advantageously, the present embodiments provide a system and method for accurately measuring parameters of tire beads or other circular components with relatively large diameters even when the field of a specific measurement device, such as the field of view of the camera 314, is limited. While a component of any suitable size can be measured using the measurement system 300, in non-limiting exemplary embodiments, the measurement system 300 may be sized and designed to handle tire beads or other components with a diameter of up to 60 inches (or more) and as little as 10 inches (or less). Further, the present measurement system 300 provides the advantage of allowing the camera 314 to be positioned relatively close to the background surface 304 (and the component being measured) for enhanced accuracy and precision. Similarly, since the camera 314 may be positioned close to the measured component and/or background surface 304, a step of correcting the measurement to compensate for the angle and distance of a conical field of view of certain camera lenses may not be necessary. Additionally, the ability to measure with a relatively small field of view may allow the camera 314 to include a telecentric lens or other specialty lens, which may further enhance the precision and accuracy of the measurement system 300.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

We claim:

1. A measurement system for measuring at least one parameter of a tire component, the measurement system comprising:
a background surface;
a circular visual indicator located on the background surface;
a support arm that is rotatable about an axis, the axis being substantially perpendicular to the background surface; and
a camera secured to the support arm such that, when the support arm rotates about the axis, the camera follows a circular path along the background surface.

2. The measurement system of claim 1, wherein the camera is configured to detect a distance between the circular visual indicator and a tire component to determine a dimension of the tire component.

3. The measurement system of claim 1, wherein the circular path is concentric with the circular visual indicator.

4. The measurement system of claim 1,
wherein the camera is movable along the support arm from a first position to a second position,
wherein in the first position, the circular path has a first diameter,
wherein in the second position, the circular path has a second diameter, and
wherein the first diameter is greater than the second diameter.

5. The measurement system of claim 4, wherein when the camera is located in one of the first position and the second position, the diameter of the circular path is substantially equal to a diameter of the circular visual indicator, and the circular path is substantially concentric with the circular visual indicator.

6. The measurement system of claim 1, further comprising a linear actuation device coupled to the support arm and configured for moving the camera along the support arm.

7. The measurement system of claim 1, further comprising a rotation actuation device fixed with respect to the background surface and configured to rotation the support arm about the axis.

8. The measurement system of claim 1, wherein the background surface is configured to contact and support a tire bead that is placed on the background surface.

9. The measurement system of claim 1, further comprising a transparent support surface located between the camera and the background surface, the transparent support surface being configured to contact and support a tire bead that is placed on the background surface.

10. A measurement system for measuring at least one parameter of a tire component, the measurement system comprising:
a background surface;
a support arm that is rotatable about an axis, the axis being substantially perpendicular to the background surface; and
a first measurement device secured to the support arm,
wherein the first measurement device is movable along the support arm from a first position to a second position.

11. The measurement system of claim 10, further comprising a circular visual indicator located on the background surface.

12. The measurement system of claim 11, wherein the axis is concentric with the circular visual indicator.

13. The measurement system of claim 11, wherein the measurement device is configured to detect a distance between the circular visual indicator and a tire component to determine a dimension of the tire component.

14. The measurement system of claim 10,
wherein the measurement device moves along a circular path when the support arm rotates,
wherein in the first position, the circular path has a first diameter,
wherein in the second position, the circular path has a second diameter, and
wherein the first diameter is greater than the second diameter.

15. The measurement system of claim 14, further comprising a circular visual indicator located on the background surface, wherein when the measurement device is located in one of the first position and the second position, the diameter of the circular path is substantially equal to a diameter of the circular visual indicator, and the circular path is substantially concentric with the circular visual indicator.

16. The measurement system of claim 10, further comprising a linear actuation device coupled to the support arm and configured for moving the measurement device along the support arm.

17. The measurement system of claim 10, further comprising a rotation actuation device fixed with respect to the background surface and configured to rotation the support arm about the axis.

18. A method, the method comprising:
placing a tire component on a support surface in a manner such that the tire component is at least approximately concentric with a circular visual indicator located on a background surface;
determining a measured distance with a camera, wherein the measured distance is a distance between the tire component and the circular visual indicator; and
determining a parameter of the tire component based on the measured distance.

19. The method of claim 18, further comprising rotating a support arm, wherein the camera is fixed with respect to the support arm such that the camera moves along a circular path that is concentric with the circular visual indicator.

20. The method of claim 19, further comprising moving the camera along the support arm to change a diameter of the circular path.
